(19) United States
(12) Patent Application Publication
(10) Pub. No.: US 2010/0311890 A1
(43) Pub. Date: Dec. 9, 2010

(54) CURABLE COMPOSITIONS THAT FORM A LOW MODULUS POLYUREA

(75) Inventors: George Yakulis, JR., Allison Park, PA (US); Edward R. Millero, JR., Gibsonia, PA (US); Howard L. Senkfor, South Euclid, OH (US); Steven V. Barancyk, Wexford, PA (US); Debra Singer, Wexford, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 12/478,987

(22) Filed: Jun. 5, 2009

(51) Int. Cl. C08K 3/36; C08K 3/34; C08G 18/44; C08L 67/00; C08L 75/04

(52) U.S. Cl. 524/447; 524/445; 524/500; 524/537; 524/539; 524/590

(57) ABSTRACT

The present invention is directed to curable, two-package compositions comprising a first and second reactive package. The first reactive package comprises:
a) a polyamine component comprising:
   i) an aspartic ester functional polyamine; and
   ii) an aromatic polyamine; and
b) a rheology modifier.

The second reactive package comprises a polyisocyanate, and the curable composition, upon mixing of the reactive packages, demonstrates a gel time of at least 10 minutes.

### FIELD OF THE INVENTION

The present invention relates to curable compositions demonstrating long gel times, and that form polyurea compositions with low modulus.

### BACKGROUND OF THE INVENTION

Polyurea elastomers have been among the curable compositions commercially applied to various substrates to provide protection to the substrates and to improve properties of the substrates. Polyurea compositions have been used as protective coatings in industrial applications for coating of process equipment to provide corrosion resistance or as caulks and sealants in a variety of aggressive environments. In addition, polyurethane elastomers have been used to line rail cars and pickup truck beds. Such coatings for rail cars and pickup trucks provide protection from cosmetic damage as well as protection from corrosion, abrasion, impact damage, chemicals, UV light and other environmental conditions.

It would be desirable to provide a polyurea composition with extended workability that provides improved mechanical properties to substrates.

### SUMMARY OF THE INVENTION

The present invention is directed to curable, two-package compositions comprising a first and second reactive package. The first reactive package comprises:

a) a polyamine component comprising:
i) an aspartic ester functional polyamine; and
ii) an aromatic polyamine; and

b) a rheology modifier.

The second reactive package comprises a polyisocyanate, and the curable composition, upon mixing of the reactive packages, demonstrates a gel time of at least 10 minutes (600 seconds).

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Not withstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various embodiments and examples of the present invention as presented herein are each understood to be non-limiting with respect to the scope of the invention.

As used in the following description and claims, the following terms have the meanings indicated below:

By “polymer” is meant a polymer including homopolymers and copolymers, and oligomers. By “composite material” is meant a combination of two or more differing materials.

The term “curable”, as used for example in connection with a curable composition, means that the indicated composition is polymerizable or cross linkable through functional groups, e.g., by means that include, but are not limited to, thermal (including ambient cure) and/or catalytic exposure.

The term “cure”, “cured” or similar terms, as used in connection with a cured or curable composition, e.g., a “cured composition” of some specific description, means that at least a portion of the polymerizable and/or crosslinkable components that form the curable composition is polymerized and/or crosslinked. Additionally, curing of a polymerizable composition refers to subjecting said composition to curing conditions such as but not limited to thermal curing, leading to the reaction of the reactive functional groups of the composition, and resulting in polymerization and formation of a polymerizate. When a polymerizable composition is subjected to curing conditions, following polymerization and after reaction of most of the reactive end groups occurs, the rate of reaction of the remaining unreacted reactive end groups becomes progressively slower. The polymerizable composition can be subjected to curing conditions until it is at least partially cured. The term “at least partially cured” means subjecting the polymerizable composition to curing conditions, wherein reaction of at least a portion of the reactive groups of the composition occurs, to form a polymerizate. The polymerizable composition can also be subjected to curing conditions such that a substantially complete cure is attained and wherein further curing results in no significant further improvement in polymer properties, such as hardness.

The term “reactive” refers to a functional group capable of undergoing a chemical reaction with itself and/or other functional groups spontaneously or upon the application of heat or actinic radiation, or in the presence of a catalyst or by any other means known to those skilled in the art.

The curable compositions of the present invention comprise two reactive packages that are typically mixed together immediately prior to curing; for example, they may be mixed together immediately prior to application of the composition to a substrate as a coating. The first reactive package comprises a polyamine component and a rheology modifier. The rheology modifier may be an inorganic, organic, and/or polymeric material as discussed below, and may further comprise a pigment. The polyamine component may include diamines, triamines and/or other higher polyamines, and the amine groups may be primary or secondary. The polyamine component comprises an aspartic ester functional polyamine and an aromatic polyamine. In particular embodiments of the present invention the aspartic ester functional polyamine is a cyclic aspartic ester functional polyamine. Not intending to be bound by theory, it is believed that cyclic groups on the aspartic ester functional polyamine contribute to steric hindrance such that reaction of the amine groups with isocyanate is slowed sufficiently to allow for extended workability time by increasing gel time of the composition, compared to conventional polyamine compositions used to prepare polyureas. Suitable cyclic aspartic ester functional polyamines include those available from Bayer MaterialScience as DESMOPHEN NH 1420 and 1520, more often DESMOPHEN NH 1420.

Suitable aromatic polyamines include aromatic diamines, such as phenylene diamines and toluene diamines, for example o-phenylene diamine and p-tolylene diamine. Polynuclear aromatic diamines such as 4,4′-biphenyl diamine, methylene dianiline and monochloromethylene dianiline are also suitable. Aromatic polyamines used most often include UNILINK 4200, an aromatic diamine available from Dorf Ketal. In a particular embodiment, this aromatic diamine in combination with a cyclic aspartic ester functional polyamine provides extended pot life and workability time to the curable composition of the present invention.

The polyamine component in the first reactive package typically contains 10 to 35, often 20 to 35, more often 25 to 30 percent by weight of the aspartic ester functional polyamine; and 5 to 30, often 15 to 30, more often 15 to 20 percent by weight of the aromatic polyamine, based on the total weight of solids in the first reactive package.

The polyamine component in the first reactive package may further comprise additional polyamines different from those already present. Additional polyamines may include those disclosed in Paragraphs [0026]-[0029] of U.S. Ser. No. 12/122,980, incorporated by reference herein, provided that upon mixing of the reactive packages, the curable composition demonstrates a gel time of at least 10 minutes (600 seconds). Examples of particularly suitable aliphatic polyamines include, without limitation, ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluoylene diamine, 2,4′- and/or 4,4′-diamino-dicyclohexyl methane and 3,3′-dialkyl-4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane, or mixtures thereof. Cycloaliphatic diamines are available commercially from Huntsman Corporation (Houston, Tex.) under the designation of JEFFLINK™ such as JEFFLINK™ 754. In particular embodiments of the present invention, for example, the polyamine component may further comprise a polyether functional polyamine, typically a diamine or triamine. Examples of suitable polyether functional polyamines include those sold under the name JEFFAMINE, such as JEFFAMINE D2000, a polyether functional diamine available from Huntsman Corporation. Such polyether functional polyamines are typically present in an amount of 5 to 40 percent by weight, often 15 to 35 percent by weight, based on the total weight of solids in the first reactive package. Additional aliphatic cyclic polyamines may also be included, such as DESMOPHEN NH 1520 cited above, and/or CLEARLINK 1000, which is a secondary aliphatic diamine available from Dorf Ketal. Aliphatic cyclic diamines are typically present in an amount of 10 to 30 percent by weight, often 10 to 20 percent by weight, and more often 10 to 15 percent by weight, based on the total weight of solids in the first reactive package. Moreover, additional aspartic ester functional diamines that are different from the other polyamines in the polyamine component may be included in the polyamine component. In particular embodiments, a linear secondary aspartic ester functional diamine may be used. Not intending to be bound by theory, it is believed that when used in small amounts, such a diamine may shorten tack free time and prevent sag of the curable composition when applied to a substrate, without significantly decreasing gel time. One example of such polyaspartic esters is the derivative of diethyl maleate and 1,5-diamino-2-methylpentane, available commercially from Bayer MaterialScience under the name Desmophen NH 1220, typically used in an amount of 1 to 20 percent by weight or 1 to 10 percent by weight, based on the total weight of solids in the first reactive package. Other suitable amine functional compounds containing aspartate groups may be employed as well. Additionally, the polyamines can include polyaspartic esters which can include derivatives of compounds such as maleic acid, fumaric acid esters, aliphatic polyamines and the like. All of the polyamines listed above may be used alone or in various combinations depending on the desired properties of the cured composition.

In certain embodiments of the present invention, the polyamine component further comprises an additional resin that is different from the amine functional component. The additional resin may or may not be reactive with the polyisocyanate, and may comprise, for example, a polyether, a polyol, a thiol ether, a polycarbonate and/or a polyester. The resin may have mono-, di-, tri- or higher functionality. Such resins, when used, may be present in an amount of 2 to 15 percent by weight, based on the total weight of solids in the first reactive package.

The first reactive package further comprises a rheology modifier. The rheology modifier may be inorganic, organic or polymeric based. An example of a polymeric rheology modifier is BYK-410, available from Byk-Chemie. Inorganic rheology modifiers include, for example, a silica such as fumed silica and/or a clay. The clay may be selected from montmorillonite clays such as bentonite, kaolin clays, attapulgite clays, sepiolite clay, and mixtures thereof. Additionally, the clay may be surface treated as is known in the art. Any suitable surface treatment may be used; for example, one or more amines according to the following structures:

R¹—N R²R³

R¹—N⁺R²R³R⁷

R⁴—C(O)—NR⁵—R⁶—NR²R³

R⁴—C(O)—NR⁵—R⁶—N⁺R²R³R⁷

wherein R¹ and R⁴ are independently C₄-C₂₄ linear, branched, or cyclic alkyl, aryl, alkenyl, aralkyl or aralkyl, R², R³, R⁵ and R⁷ are independently H or C₁-C₂₀ linear, branched, or cyclic alkyl, aryl, alkenyl, aralkyl or aralkyl, and R⁶ is C₁-C₂₄ linear, branched, or cyclic alkylene, arylene, alkenylene, aralkylene or aralkylene. As a non-limiting example, surface treated bentonite may be used, such as the alkyl ammonium bentonites described in U.S. Pat. No. 3,974,125.

In certain embodiments of the invention, the clay may be present in the curable composition at a level of at least 0.5 percent by weight, in some cases at least 1 percent by weight and in other cases at least 1.5 percent by weight, based on the total weight of the curable composition. When the amount of clay is too low, the composition can have poor rheological properties. Also, the clay can be present at up to 8 percent by weight, in some cases up to 5 percent by weight, and in other cases up to 4 percent by weight of the composition. When the amount of clay is too high, the viscosity of the composition can be too high to handle effectively. The amount of clay in the two-package composition can be any value or range between any values recited above. The clay may optionally be present in place of or in combination with other rheology modifiers.

In another embodiment of the invention, the curable composition may include a silica in addition to or in place of clay or other rheology modifiers. Any suitable silica can be used, so long as it is a suitable thixotrope. In a particular embodiment of the invention, the silica is fumed silica. Examples of commercially available silica include CABOSIL M5, available from Cabot Corporation, and AEROSIL 200, from Evonik Industries.

When present, the silica is present in the two-package composition at a level of at least 0.5 percent by weight, in some cases at least 1 percent by weight and in other cases at least 1.5 percent by weight based on the total weight of solids in the composition. When the amount of silica is too low, the composition can have poor rheological properties as well as less than desirable adhesion properties. Also, the silica can be present at up to 8 6 percent by weight, in some cases up to 5 percent by weight, and in other cases up to 4 percent by weight of the composition. When the amount of silica is too high, the viscosity of the composition can be too high to handle effectively. The amount of silica in the curable composition can be any value or range between any values recited above.

Pigments may be included with the rheology modifier or may be added to either reactive package of the composition, or to the composition after mixing of the two reactive packages. Pigments serve several purposes, including coloring and/or rheology control (e.g., thixotropy) of the composition, and may be used in combinations. Pigments include TiO₂, carbon black and/or graphite. In particular embodiments of the present invention, a flame retardant material comprising graphite can be added to the isocyanate and/or the amine component of the coating compositions of the present invention. Suitable graphites are known in the art and can include natural and synthetic graphites. Non-limiting examples of suitable graphites can include expandable graphite and/or exfoliated graphite. In certain embodiments, expandable graphite in the form of a solid or powder is intercalated with an acid such as, but not limited to, organic acids (e.g. acetic acid) and inorganic acids (e.g. H₂SO₄ and HNO₃). Non-limiting examples of such graphites include commercially available graphites under the tradenames NORD-MIN from Nano Technologies, Incorporated and NYAGRAPH including but not limited to NYAGRAPH 35, 251 and 351, from Nyacol, Incorporated. In certain embodiments, if the graphite is added to the first component, the graphite can be substantially compatible with the isocyanate functional prepolymers and the additional isocyanate.

The second reactive package in the curable, two-package composition of the present invention comprises a polyisocyanate. As used herein, the term “isocyanate” includes unblocked isocyanate compounds capable of forming a covalent bond with a reactive group such as a hydroxyl, thiol or amine functional group. Thus, isocyanate can refer to “free isocyanate”, which will be understood to those skilled in the art. Combinations of any isocyanates and/or isocyanate functional prepolymers can be used according to the present invention.

Suitable isocyanates for use in the present invention include monomeric and/or polymeric isocyanates. The isocyanates can be selected from monomers, prepolymers, oligomers, or blends thereof. The isocyanate can be C₂-C₂₀ linear, branched, cyclic, aromatic, aliphatic, or combinations thereof.

Suitable isocyanates for use in the present invention may include isophorone diisocyanate (IPDI), which is 3,3,5-trimethyl-5-isocyanato-methyl-cyclohexyl isocyanate; hydrogenated materials such as cyclohexylene diisocyanate, 4,4′-methylenedicyclohexyl diisocyanate (H₁₂MDI); mixed aralkyl diisocyanates such as tetramethylxylyl diisocyanates, OCN—C(CH₃)₂—C₆H₄C(CH₃)₂—NCO; polymethylene isocyanates such as 1,4-tetramethylene diisocyanate, 1,5-pentamethylene diisocyanate, 1,6-hexamethylene diisocyanate (HMDI), 1,7-heptamethylene diisocyanate, 2,2,4- and 2,4,4-trimethylhexamethylene diisocyanate, 1,10-decamethylene diisocyanate and 2-methyl-1,5-pentamethylene diisocyanate; and mixtures thereof.

Non-limiting examples of aromatic isocyanates for use in the present invention may include phenylene diisocyanate, toluene diisocyanate (TDI), xylene diisocyanate, 1,5-naphthalene diisocyanate, chlorophenylene 2,4-diisocyanate, bitoluene diisocyanate, dianisidine diisocyanate, tolidine diisocyanate, alkylated benzene diisocyanates, methylene-interrupted aromatic diisocyanates such as methylenediphenyl diisocyanate, 4,4′-isomer (MDI) including alkylated analogs such as 3,3′-dimethyl-4,4′-diphenylmethane diisocyanate, polymeric methylenediphenyl diisocyanate; and mixtures thereof.

In certain embodiments, isocyanate monomer may be used. It is believed that the use of an isocyanate monomer (i.e., residual-free monomer from the preparation of prepolymer) may decrease the viscosity of the polyurea composition thereby improving its flowability, and may provide improved adhesion of the polyurea coating to a previously applied coating and/or to an uncoated substrate. In alternate embodiments of the present invention, at least 1 percent by weight, or at least 2 percent by weight, or at least 4 percent by weight of the isocyanate component comprises at least one isocyanate monomer.

In certain embodiments of the present invention, the isocyanate can include oligomeric isocyanate such as but not limited to dimers such as the uretdione of 1,6-hexamethylene diisocyanate, trimers such as the biuret and isocyanurate of 1,6-hexanediisocyanate and the isocyanurate of isophorone diisocyanate, allophonates and polymeric oligomers. Modified isocyanates can also be used, including carbodiimides and uretone-imines, and mixtures thereof. Suitable materials include those available under the designation DESMODUR from Bayer Corporation of Pittsburgh, Pa., such as DESMODUR N 3200, DESMODUR N 3300, DESMODUR N 3400, DESMODUR XP 2410 and DESMODUR XP 2580.

In some embodiments, the isocyanate component comprises an isocyanate functional prepolymer formed from a reaction mixture comprising an isocyanate and another material. Any isocyanate known in the art, such as any of those described above, can be used in the formation of the prepolymer. As used herein, an “isocyanate functional prepolymer” refers to the reaction product of isocyanate with polyamine and/or other isocyanate reactive group such as polyol; the isocyanate functional prepolymer has at least one isocyanate functional group (NCO).

In certain embodiments of the present invention, an isocyanate functional prepolymer comprises isocyanate that is pre-reacted with a material comprising a flame retardant material, such as a phosphorus-containing polyol. Suitable isocyanate functional prepolymers comprising a flame retardant material are disclosed in Paragraphs [0017]-[0023] of U.S. Ser. No. 12/122,980, incorporated by reference herein. As described in that excerpt, in certain embodiments the phosphorus containing polyol can itself be the reaction product of a phosphorus containing polyol, sometimes referred to as an “initial” phosphorus containing polyol, and another compound.

A polyurea coating composition that can exhibit improved flame and/or heat resistance can comprise any phosphorus-containing isocyanate prepolymer. As used herein, the term “flame retardant”, “flame resistant”, “heat retardant”, “heat resistant” and the like refers to the ability to withstand flame or heat without igniting, the ability to limit damage to the coating and/or limit the ability of the coating to burn. As used herein, the terms “improved flame resistance” and “improved heat resistance” means any degree of improved flame resistance or heat resistance, respectively that is demonstrated by a coating composition with flame retardant material as compared to a coating composition, such as the same coating composition, without flame retardant material.

In some embodiments, however, the polyol used in the formation of the pre-polymer is not a phosphorus containing polyol. Suitable non-phosphorous containing polyols include, for example, polytetrahydrofuran materials such as those sold under the trade name TERATHANE (e.g., TERATHANE 250, TERATHANE 650, TERATHANE 1000 available from Invista Corporation).

In certain embodiments, the isocyanate component comprises an isocyanate (non-prepolymer isocyanate) and an isocyanate functional prepolymer. The non-prepolymer isocyanate can be the same or different from the isocyanate used to form the isocyanate functional prepolymer. If combinations of isocyanates are used, the isocyanates should be substantially compatible, for example; the isocyanate functional prepolymers can be substantially compatible with the non-prepolymer isocyanate. As used herein, “substantially compatible” means the ability of a material to form a blend with other materials that is and will remain substantially homogeneous over time. The reaction of an isocyanate with an organic material, such as in the formation of an isocyanate functional prepolymer, helps to compatibilize the isocyanate.

In particular embodiments of the present invention, the polyisocyanate comprises a polyether polyol, polyester polyol, a phosphorus-containing polyol and/or a polyether polyamine prepolymer chain-extended with a polyisocyanate selected from isophorone diisocyanate, cyclohexylene diisocyanate, 4,4′-methylenedicyclohexyl diisocyanate; tetramethylxylyl diisocyanates, 1,4-tetramethylene diisocyanate, 1,5-pentamethylene diisocyanate, 1,6-hexamethylene diisocyanate, 1,7-heptamethylene diisocyanate, 2,2,4- and 2,4,4-trimethylhexamethylene diisocyanate, 1,10-decamethylene diisocyanate, 2-methyl-1,5-pentamethylene diisocyanate, phenylene diisocyanate, toluene diisocyanate, xylene diisocyanate, 1,5-naphthalene diisocyanate, chlorophenylene 2,4-diisocyanate, bitoluene diisocyanate, dianisidine diisocyanate, tolidine diisocyanate, methylenediphenyl diisocyanate, 3,3′-dimethyl-4,4′-diphenylmethane diisocyanate, polymeric methylenediphenyl diisocyanate, and mixtures thereof.

The curable compositions of the present invention can include a variety of optional ingredients and/or additives that are somewhat dependent on the particular application of the curable composition, such as reinforcements, accelerators, catalysts, surfactants, plasticizers, extenders, oligomers such as urethane and acrylates, additional rheology additives, stabilizers, diluents, antioxidants, fire retardants, UV agents, hindered amine light stabilizers (monomeric and polymeric) and/or chemical blowing agents. These additives may be present in either or both of the reactive packages. Generally, the amount of optional additional ingredients is up to about 30 weight percent, such as up to 5 percent by weight, or up to 1 percent by weight, based on the total weight of the curable composition and depending on the nature of the ingredient.

Diluents and plasticizers can be present in an amount of up to about 50 weight percent of the total weight of the curable composition. Examples of suitable diluents include low molecular weight (from about 100 to about 2000) aliphatic or aromatic ester compounds containing one or more ester linkages, and low molecular weight aliphatic or aromatic ethers containing one or more ether linkages and combinations thereof. Reactive diluents are designed to modify strength and/or adhesion of the cured composition, such as aliphatic and/or aromatic mono, di, or tri epoxides having a weight average molecular weight of about 300 to about 1500, can be present in the range of up to about 30 weight percent of the total weight of the curable composition (preferably 5 to 10 percent).

The compositions of the present invention are typically liquid. By “liquid” is meant that the compositions have a viscosity that allows them to be at least extrudable. The compositions may have a viscosity that allows them to be at least pumpable, and even at least sprayable. Typically, upon mixing of the reactive packages, the compositions demonstrate a complex viscosity that allows them to be applied to a substrate as a continuous film with a blade for as long as sixty minutes; in some embodiments, for as long as ninety minutes. For example, in certain embodiments of the present invention, at sixty minutes after mixing of the reactive packages, the composition demonstrates a complex viscosity of up to 6,000,000 at 75° F. (23.9° C.), 1 Hz frequency and a strain of 5%. Complex viscosity is defined as a frequency-dependent viscosity function determined during forced harmonic oscillation of shear stress on a fluid being tested. It is typically measured with a rheometer such as an Anton-Paar MCR 301 rheometer. Moreover, upon mixing of the reactive packages, the compositions typically demonstrate a complex viscosity that allows them to be applied to a substrate as a continuous film with a brush for as long as fifteen minutes; in some embodiments, for as long as thirty minutes. For example, in certain embodiments of the present invention, at fifteen minutes after mixing of the reactive packages, the composition demonstrates a complex viscosity of up to 300,000 at 75° F. (23.9° C.), 1 Hz frequency and a strain of 5%.

Liquid compositions that are suitable for use in the present invention include liquid resin systems that are 100 percent solids, liquid resins that are dissolved or dispersed in a liquid medium, and solid particulate resins that are dispersed in a liquid medium. Liquid media may be aqueous based or organic solvent based. Often, the curable compositions of the present invention are essentially free of organic solvent and water, for example, containing less than three percent by weight of organic solvent and/or water, based on the total weight of the compositions.

The curable compositions of the present invention can be prepared as a two-package composition, usually curable at ambient temperature. Two package curable compositions are typically prepared by mixing the two packages immediately before use.

Substrates to which compositions of the present invention may be applied include rigid or flexible metal substrates and/or foils such as titanium, ferrous metals, aluminum, aluminum alloys, copper, and other metal and alloy substrates. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations or composites of ferrous and non-ferrous metals can also be used.

The compositions of the present invention are particularly suitable as coatings on walls such as concrete, concrete block walls, brick walls, and the like.

The substrate to which the composition of the present invention is applied may be a bare, cleaned surface; it may be oily, pretreated with one or more pretreatment compositions, and/or prepainted with one or more coating compositions, primers, etc., applied by any method including, but not limited to, spraying, dip coating, roll coating, curtain coating, and the like.

In certain embodiments of the present invention, the curable composition is formed by preparing the first and second reactive packages such that the ratio of equivalents of isocyanate groups to equivalents of amine groups is greater than 1 while the volume ratio of the first reactive package to the second reactive package is 1:1; mixing the reactive packages in a 1:1 volume ratio to produce a reaction mixture; and then applying the reaction mixture to a substrate to form a polyurea coating on the substrate. Those skilled in the art would understand that other mix ratios are possible while maintaining the ratio of equivalents of isocyanate groups to equivalents of amine groups as greater than 1, since the first and second reactive components can be freely poured and mixed together in any suitable vessel or container. Any weight or volume mix ratio is possible; 1:1 is convenient.

The composition may be applied to the substrate by one or more of a number of methods including spraying, extruding, brushing, or by hand with a blade. Applying the composition to a substrate by hand with a blade, brush, or the like reduces the level of airborne reactants, compared to spray application.

The compositions can be cured by allowing them to stand at ambient temperature, or a combination of ambient temperature cure and baking, or by baking alone. The compositions can be cured at ambient temperature typically in a period ranging from about 12 hours to about 96 hours, usually 24 to 36 hours.

In certain embodiments of the present invention, after application of the composition of the present invention to a substrate and upon curing, the composition demonstrates a Young's Modulus at 25° C. of less than 200 psi, often less than 150 psi.

The following examples are intended to illustrate various embodiments of the invention, and should not be construed as limiting the invention in any way.

### EXAMPLES

A compatible isocyanate component comprising an isocyanate-functional prepolymer was prepared from the following ingredients as described below:

### Example 1

### Isocyanate Functional Prepolymer

| Ingredients | Parts by Weight (grams) |
|---|---|
| ISOPHORONE DIISOCYANATE | 968 |
| TERATHANE 650¹ | 1363 |
| DIBUTYLTIN DILAURATE | 0.15 |
| DESMODUR XP2580² | 4329 |

¹Polyether diol available from DuPont.
²Polyisocyanate available from Bayer Material Science Corporation.

A total of 968 grams of ISOPHORONE DIISOCYANATE was placed in a suitable reaction vessel equipped with a stirrer, temperature probe, a condenser and a nitrogen inlet tube and blanketed with nitrogen gas. A total of 1363 grams of TERATHANE 650 and was then added and mixed for 15 minutes at ambient temperature. Then, 0.15 grams of DIBUTYLTIN DILAURATE was added and the mixture was heated slowly to 50° C., then to 80° C. and finally to 126° C. The contents of the reactor were cooled to 80° C. and the isocyanate equivalent weight of the resin was measured and found to be 531 grams per equivalent. A total of 4329 grams of DESMODUR XP2580 was then added to the contents of the flask, mixed well and the contents of the reactor were held at 80° C. for 1 hour. The content of the reactor were then cooled and poured out. The final material was a clear, compatible resin with a measured solids of 97% and an isocyanate equivalent weight of 272 grams per equivalent.

A grind paste for the amine component was prepared from the following ingredients as described below:

### Examples 2 & 3

### Grind Paste for Amine Component

| | Example 2 | Example 3 |
|---|---|---|
| Ingredient | wt. in parts | wt. in parts |
| Clearlink 1000¹ | 13.89 | 0 |
| Desmophen NH1420² | 20.83 | 0 |
| Desmophen NH1520² | 0 | 44.8 |
| Unilink 4200³ | 20.83 | 14.9 |
| Jeffamine D2000⁴ | 27.78 | 22.4 |
| Aerosil 200⁵ | 8.22 | 8.58 |
| Bentone 34⁶ | 2.78 | 2.99 |
| TiPure R960-09⁷ | 5.56 | 5.97 |
| Vulcan XC72 Black⁸ | 0.12 | 0.36 |
| Total | 100.00 | 100.00 |

¹Available from Dorf Ketal
²Available from Bayer Material Science Corporation
³Available from Dorf Ketal
⁴Available from Huntsman Corp.
⁵Available from Degussa
⁶Available from Elementis Specialties
⁷Available from DuPont
⁸Available from Cabot Corp.

The ingredients were combined and charged to a Premier Mill HM 1.5 VSD Series SuperMill (SPX Corporation) with an 85 percent charge of 1.0 mm Mill Mates Plus TZP grind medium (Zircoa, Inc.) and ground at a mill speed of 2400 rpm. The grinds were judged to be complete when the particle size was found to be 7.5 Hegman upon drawdown on a fineness of grind gauge.

An amine component was prepared from the following ingredients as described below:

### Examples 4-8

### Preparation of Amine Component

| | Example 4 | Example 5 | Example 6 | Example 7 | Example 8 |
|---|---|---|---|---|---|
| | wt. in | wt. in | Wt. in | Wt. in | Wt. in |
| Ingredient | parts | parts | parts | parts | parts |
| Grind Paste | 72.0 | 72.0 | 0.0 | 72.0 | 72.0 |
| of | | | | | |
| Example 2 | | | | | |
| Grind Paste | 0.0 | 0.0 | 67.0 | 0.0 | 0.0 |
| of | | | | | |
| Example 3 | | | | | |
| Unilink 4200 | 13.0 | 3.0 | 18.0 | 3.0 | 13.0 |
| Clearlink | 0.0 | 0.0 | 10.0 | 0.0 | 0.0 |
| 1000 | | | | | |
| Jeffamine | 0.0 | 10.0 | 5.0 | 5.0 | 0.0 |
| D2000 | | | | | |
| Desmophen | 10.0 | 10.0 | 0.0 | 10.0 | 10.0 |
| 1420 | | | | | |
| Desmophen | 5.0 | 5.0 | 0.0 | 5.0 | 5.0 |
| 1220¹ | | | | | |
| Fyrol PCF² | 0.0 | 0.0 | 0.0 | 5.0 | 0.0 |
| Total | 100.0 | 100.0 | 100.0 | 100.0 | 100.0 |

¹Available from Bayer Material Science Corp.
²Available from Supresta

The ingredients listed in the table above were then added together at ambient conditions.

### Examples 9 Thru 13

Polyurea coating compositions of the invention were prepared from combining an isocyanate functional “A” side component and an amine functional “B” side component in the following manner: Polyurea coating compositions were produced by mixing a 1:1 volume ratio of each of the A-side components to each the B-side components in a static mix tube applicator device available from Plas-Pak Industries, Inc. The coating compositions were drawn down over polyethylene sheet to obtain free films for tensile testing per ASTM D 638-08. The Gel time was determined by using a GARDCO Gel Timer by Paul N. Garner Company Inc.

TABLE 1

| | Examples | | | | |
|---|---|---|---|---|---|
| | 9 | 10 | 11 | 12 | 13 |
| Isocyanate “A side” | Exam- | Exam- | Exam- | Example 1 | Desmodur |
| | ple 1 | ple 1 | ple 1 | | XP-2580¹ |
| Amine “B side” | Exam- | Exam- | Exam- | Example 7 | Example 8 |
| | ple 4 | ple 5 | ple 6 | | |
| Young's Modulus, | 337.45 | 75.5 | 38.57 | 67.1 | 573.32 |
| MPa | | | | | |
| (ASTM D638-08) | | | | | |
| Tensile Strength, | 16.99 | 15.50 | 14.06 | 13.3 | 22.59 |
| MPa (ASTM D638- | | | | | |
| 08) | | | | | |
| % Elongation | 180.3 | 293.6 | 393.2 | 237.4 | 148.7 |
| (ASTM D638-08) | | | | | |
| Gel time (sec.) | 1126 | 1204 | 2491 | 1485 | 1021 |

¹Available from Bayer Material Science Corp

As can be seen from Table 1, the physical properties and gel time can be adjusted for a variety of coating applications (brush, trowel, static mix spray or static mix caulk) and tensile properties.

Example 9 of the invention was prepared by combining an isocyanate functional “A” side component (Example 1) and an amine functional “B” side component (Example 4) in the following manner: Polyurea coating compositions were produced by mixing a 1:1 volume ratio of each of the A-side components to each the B-side components in a static mix tube applicator device available from Plas-Pak Industries, Inc. The coating composition was deposited on an Anton-Paar MCR 301 rheometer with 25 mm ring tool and a 0.7 mm gap. Complex viscosity was measured as a function of time at 75° F. The oscillation mode was 1 Hz frequency and a strain of 5%.

TABLE 2

| Time (minutes) | Complex Viscosity (centipoises) |
|---|---|
| 10 | 108,000 |
| 15 | 209,000 |
| 30 | 919,000 |
| 60 | 5,720,000 |
| 90 | 17,400,000 |

Whereas particular embodiments of this invention have been described above for purposes of illustration, it will be evident to those skilled in the art that numerous variations of the details of the present invention may be made without departing from the scope of the invention as defined in the appended claims.

Therefore, what is claimed is:

1. A curable, two-package composition comprising a first and second reactive package, wherein the first reactive package comprises:
a) a polyamine component comprising:
i) an aspartic ester functional polyamine; and
ii) an aromatic polyamine; and
b) a rheology modifier; and
wherein the second reactive package comprises a polyisocyanate; and wherein the curable composition, upon mixing of the reactive packages, demonstrates a gel time of at least 10 minutes (600 seconds).

2. The curable composition according to claim 1, wherein the aspartic ester functional polyamine (i) is a cyclic aspartic ester functional polyamine.

3. The curable composition according to claim 2, wherein upon mixing of the reactive packages, the composition demonstrates a complex viscosity that allows the composition to be applied to a substrate as a continuous film with a blade for as long as ninety minutes.

4. The curable composition according to claim 3, wherein at sixty minutes after mixing of the reactive packages, the composition demonstrates a complex viscosity of up to 6,000,000 cps at 75° F. (23.9° C.), 1 Hz frequency and a strain of 5%.

5. The curable composition according to claim 2, wherein upon mixing of the reactive packages, the composition demonstrates a complex viscosity that allows the composition to be applied to a substrate as a continuous film with a brush for as long as thirty minutes.

6. The curable composition according to claim 5, wherein at fifteen minutes after mixing of the reactive packages, the composition demonstrates a complex viscosity of up to 300,000 cps at 75° F. (23.9° C.), 1 Hz frequency and a strain of 5%.

7. The curable composition according to claim 2, wherein the polyamine component (a) comprises a mixture of primary and secondary amines.

8. The curable composition of claim 2, wherein the polyamine component (a) further comprises a polyether functional diamine and/or triamine, present in an amount of 5 to 40 percent by weight, based on the total weight of solids in the first reactive package.

9. The curable composition of claim 2, wherein the aromatic polyamine (ii) comprises an aromatic diamine, present in an amount of 5 to 30 percent by weight, based on the total weight of solids in the first reactive package.

10. The curable composition according to claim 2, wherein the polyamine component (a) comprises diamines and/or triamines.

11. The curable composition according to claim 2, wherein the polyamine component (a) further comprises an aliphatic cyclic diamine that is different from the other polyamines in the polyamine component, present in an amount of 10 to 30 percent by weight, based on the total weight of solids in the first reactive package.

12. The curable composition according to claim 2, wherein the polyamine component (a) comprises:
i) 10 to 35 percent by weight of the cyclic aspartic ester functional polyamine; and
ii) 15 to 20 percent by weight of the aromatic polyamine, based on the total weight of solids in the first reactive package.

13. The curable composition according to claim 12, wherein the polyamine component (a) further comprises an additional aspartic ester functional diamine that is different from the other polyamines in the polyamine component, present in an amount of 1 to 20 percent by weight, based on the total weight of solids in the first reactive package.

14. The curable composition according to claim 2, wherein the rheology modifier (b) comprises a silica and/or a clay.

15. The curable composition according to claim 14, wherein the rheology modifier (b) comprises fumed silica.

16. The curable composition according to claim 14, wherein the rheology modifier (b) comprises clay selected from montmorillonite clays, kaolin clays, attapulgite clays, sepiolite clay, and mixtures thereof.

17. The curable composition according to claim 16, wherein the clay comprises surface treated bentonite.

18. The curable composition according to claim 2, wherein the polyamine component (a) further comprises an additional resin that is different from the polyamines, and that may or may not be reactive with the polyisocyanate.

19. The curable composition according to claim 18, wherein the additional resin comprises a polyether, a polyol, a thiol ether, a polycarbonate and/or a polyester.

20. The curable composition according to claim 2, wherein the polyisocyanate comprises a polyether polyol, polyester polyol, phosphorus-containing polyol and/or a polyether polyamine prepolymer chain-extended with a polyisocyanate selected from isophorone diisocyanate, cyclohexylene diisocyanate, 4,4′-methylenedicyclohexyl diisocyanate; tetramethylxylyl diisocyanates, 1,4-tetramethylene diisocyanate, 1,5-pentamethylene diisocyanate, 1,6-hexamethylene diisocyanate, 1,7-heptamethylene diisocyanate, 2,2,4- and 2,4,4-trimethylhexamethylene diisocyanate, 1,10-decamethylene diisocyanate, 2-methyl-1,5-pentamethylene diisocyanate, phenylene diisocyanate, toluene diisocyanate, xylene diisocyanate, 1,5-naphthalene diisocyanate, chlorophenylene 2,4-diisocyanate, bitoluene diisocyanate, dianisidine diisocyanate, tolidine diisocyanate, methylenediphenyl diisocyanate, 3,3′-dimethyl-4,4′-diphenylmethane diisocyanate, polymeric methylenediphenyl diisocyanate, and mixtures thereof.

21. The curable composition of claim 2, wherein the curable composition is essentially free of organic solvent and water.

22. The curable composition according to claim 2, wherein either the weight ratio or the volume ratio of the first reactive package to the second reactive package is 1:1.

23. The curable composition according to claim 2 wherein after mixing of the reactive packages and application to a substrate and upon curing, the composition demonstrates a Young's Modulus at 25° C. of less than 200 psi.

24. The curable composition according to claim 2, further comprising particulate expandable graphite.
